(19) United States
(12) Patent Application Publication
(10) Pub. No.: US 2014/0173602 A1
(43) Pub. Date: Jun. 19, 2014

(54) Matching Opportunity to Context

(71) Applicant: MICROSOFT CORPORATION, Redmond, WA (US)

(72) Inventors: Erez Kikin-Gil, Bellevue, WA (US); Matthew Kotler, Sammamish, WA (US); Andrew Brauninger, Seattle, WA (US); Ned Friend, Seattle, WA (US)

(73) Assignee: MICROSOFT CORPORATION, Redmond, WA (US)

(21) Appl. No.: 13/715,434

(22) Filed: Dec. 14, 2012

(51) Int. Cl. G06F 9/48

(52) U.S. Cl. CPC G06F 9/4843
USPC 718/100

(57) ABSTRACT

A task application for automatic task management based on content and context awareness is provided. As task items are inputted into the task application, the task items may be parsed for context data (e.g., time data, location data, people data, etc.) and associated with the task item. Additionally, context data may be input manually by a user. Task items may be stored in a “now,” “later,” “someday,” or “done” contextual task list. As context changes, (e.g., time, location, activity, people, etc.) task items with correlating context data may be prioritized. A notification may be presented to the user to alert him of an upcoming or present opportunity to achieve or complete a task item. Accordingly, a user may be provided with a list of task items that may be relevant to the user according to context.

### BACKGROUND

With current computational task management solutions, tracking which task is best to do in a specific context may be a challenge for many users, oftentimes requiring the user to go over long lists and manually reordering or segmenting tasks based on place/topic. This labor, associated with managing the task list, often pushes users to abandon using computational task management solutions and resort to traditional short-term methods such as using pen and paper to store time-critical tasks.

Another limitation with current computational task management solutions is information overload. For example, currently, a user's task items that have not been completed or that are postposed may be automatically moved to the user's task list for the next day. Accordingly, the user's task list may continue to grow in length, which may be a source of stress to the user. Current computational task management solutions do not provide an ability for the user to limit a task list to items that may be important to the user at a specific time. Accordingly, the user may be required to remember where a particular item is stored in a task list or may have to use a search functionality, requiring the user to remember a search term to use.

It is with respect to these and other considerations that the present invention has been made.

### SUMMARY

Embodiments of the present invention solve the above and other problems by providing a task application for automatic task management based on content and context awareness. As task items are inputted into the task application, the task items may be parsed for context data. Additionally, context data may be input manually by a user. Context data may include data that may be relevant to the user, for example, time data, location data, identity data (e.g., person, group, team, etc.), keyword data (e.g., object, subject, etc.), activity data, etc. Parsed and received context data may be associated with the task item so that when a relevant context is detected via various context detection methods, task items with correlating context data may be prioritized. The user may be alerted via a notification of an upcoming or present opportunity to achieve or complete a task item. Accordingly, a user may be provided with a list of task items that may be relevant to a specific context and that may help to alleviate task list information overload.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The accompanying drawings, which are incorporated in and constitute a part of this disclosure, illustrate various embodiments of the present invention. In the drawings:

FIG. 1 is an illustration of a “now” contextual task list user interface (UI);

FIG. 2 is an illustration of a task list item being marked as completed;

FIG. 3 is an illustration of a “done” contextual task list UI;

FIG. 4 is an illustration of a “later” contextual task list UI;

FIG. 5 is an illustration of a “someday” contextual task list UI;

FIG. 6 is an illustration of a task item edit UI;

FIG. 7 is an illustration of a notification displayed on a home screen UI;

FIG. 8 is a flow chart of a method for providing automatic task management based on content and context awareness;

FIG. 9 is a block diagram illustrating example physical components of a computing device with which embodiments of the invention may be practiced;

FIGS. 10A and 10B are simplified block diagrams of a mobile computing device with which embodiments of the present invention may be practiced; and

FIG. 11 is a simplified block diagram of a distributed computing system in which embodiments of the present invention may be practiced.

### DETAILED DESCRIPTION

As briefly described above, embodiments of the present invention are directed to providing automatic task management based on content and context awareness.

Embodiments of the present invention are directed to a task application that provides automatic task management based on content, context data, and context awareness. Context data may be associated with task items, which may be utilized to manage task items and to determine relevant task items to present to a user. Task items may be managed and dynamically sorted into one of a plurality of contextual task lists. Contextual task lists may include a “now” task list, a “later” task list, a “someday” task list, and a “done” task list. Task items in each contextual task list may by automatically sorted by immediacy that a user may accomplish a task item according to context and priority.

Context may include, for example, time, location, activity, incoming and/or outgoing communications, calendar events, traffic, people, etc. Context may be determined via various data capture methods. For example, location may be determined via a global positioning system (GPS) device, a radio frequency identification (RFID) device, via multilateration of radio signals between radio towers of a network and a mobile computing device, a wireless network device detection application, a barometric pressure-sensing device, etc. Incoming and outgoing communications may include emails, phone calls, social network messages, etc. Sensing people may be accomplished via voice detection using a mobile computing device's microphone, facial recognition using a mobile computing device's camera, reviewing shared calendar events, accessing other users' web content via public APIs, reviewing social media and other sources, etc. A user's actions may be determined via user interaction with a mobile computing device (e.g., opening a document, using an application, making a phone call, etc.), via an accelerometer, via a GPS device, etc. As should be appreciated, context may be determined via other methods and tools.

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

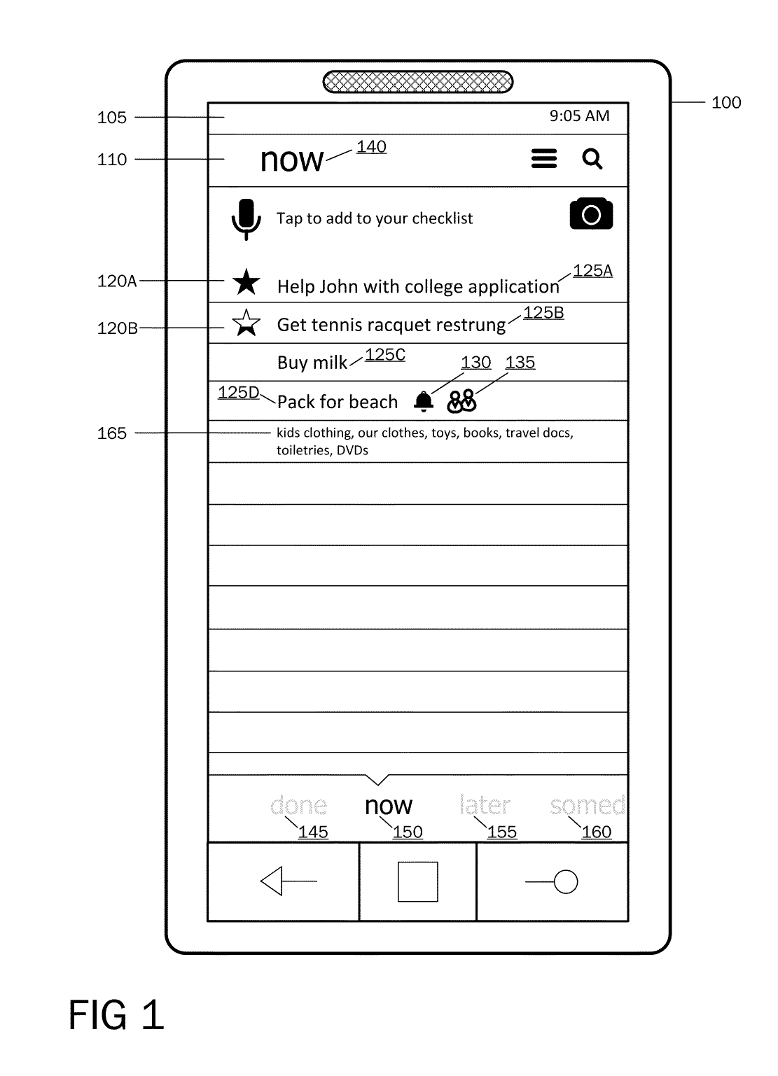

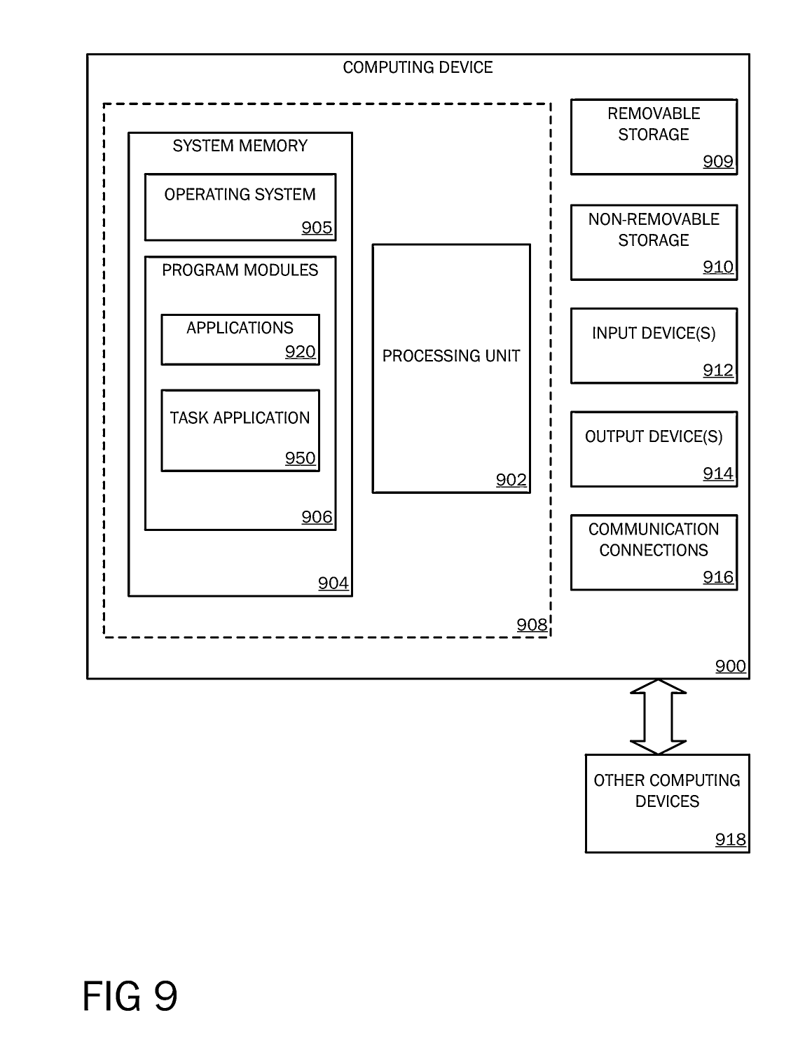

Referring now to the drawings, in which like numerals represent like elements, various embodiments will be described. Referring now to FIG. 1, a task application user interface (UI) 110 deployed on a display screen 105 of a mobile computing device 100 is illustrated. The task application 950, as illustrated in FIG. 9, includes a user interface 110 that may be displayed on a display screen 105 of a mobile computing device 100, for example, a smart phone as illustrated in FIG. 1, a tablet computing device, or other type of mobile computing device. The task application UI 110 may be divided into a plurality of contextual task list panes, each pane providing a contextual task list. According to embodiments, the contextual task list panes may include a “now” task list 140, a “later” task list, a “someday” task list, and a “done” task list.

A row of selectable task list pane functions 145,150,155,160 is illustrated at the bottom edge of the display screen 105 for providing access to the contextual task lists. As should be appreciated, the configuration and location of UI components illustrated in FIG. 1 are for purposes of example only and are not limiting of other configurations that may be possible. For example, the selectable task list pane functions 145,150,155,160 may be provided along the bottom edge of the display screen 105 as illustrated in FIG. 1, or the selectable task list pane functions 145,150,155,160 may be displayed at other locations in the display screen 105. Selection of a task list pane function 145,150,155,160 may cause a display of the selected contextual task list. For example, selection of the “now” task list pane function 150 may cause the “now” contextual task list 140 to populate the display screen 105.

According to embodiments, the “now” contextual task list 140 may include one or more task items 125 that are determined to be relevant to an immediate context. For example, with reference still to FIG. 1, the example “now” contextual list 140 includes task items “Help John with college application” (task item 125A), “Get tennis racquet restrung” (task item 125B), “Buy milk” (task item 125C), and “Pack for beach” (task item 125D). The task items 125A-D displayed in the “now” contextual task list 140 may be included because of a determination of relevancy to an immediate context. For example, the task item “Buy milk” (task item 125C) may be determined as relevant to an immediate context, wherein the immediate context may be proximity to a grocery store as determined via location detection, for example, via a GPS system.

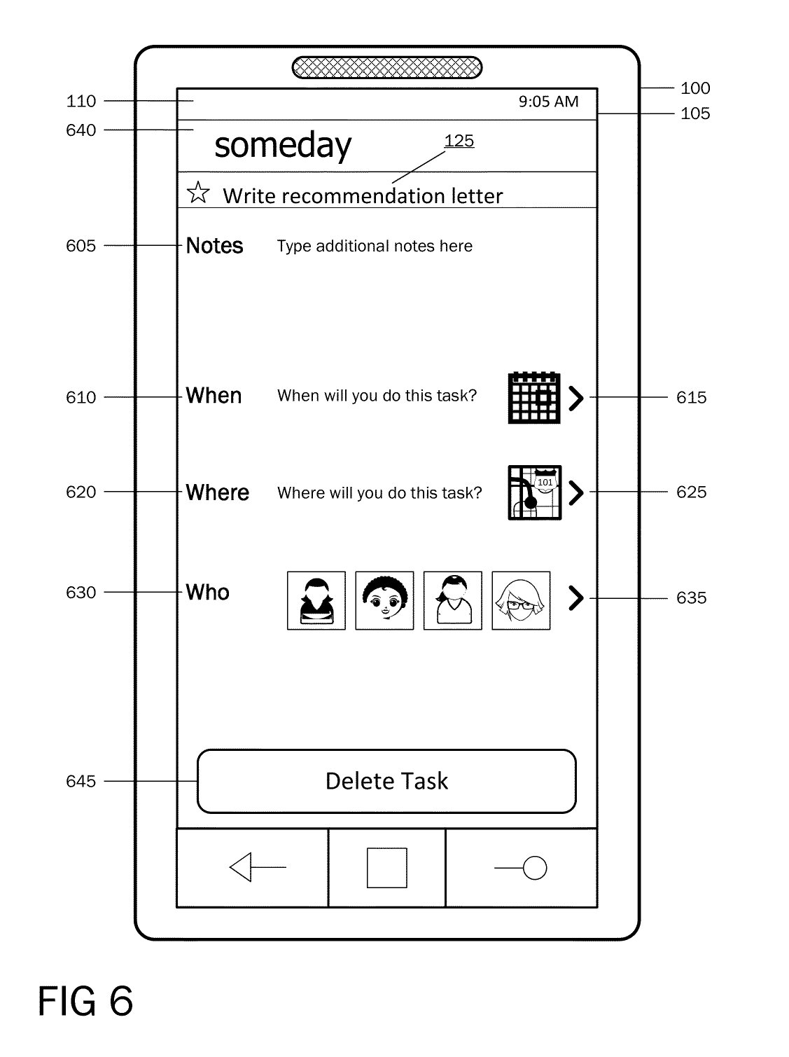

The task item “Buy milk” (task item 125C) may include context data associated with it, which may be utilized to determine relevant contexts. Context data may be associated with a task item 125 automatically and/or manually. As will be discussed in more detail with reference to FIG. 6, embodiments may include selectable functionalities for associating context data with a task item 125. Referring back to the example illustrated in FIG. 1, the location data associated with “Buy milk” (task item 125C) may include a specific location or may include reference to a location by category. For example, the user may associate a type of business, such as “grocery store” with the task item 125C or may a specific grocery store with the task item 125A. Alternatively, embodiments may automatically determine location context data for a task item 125. Context data may be associated with a specific task item 125 by parsing task information and inferring to which context the task item 125 relates. For example, using natural language processing, the terms “buy” and “milk” may be recognized as a task that may be associated with a grocery store. Accordingly, “grocery store” may be automatically saved as location context data for “Buy milk” (task item 125A). According to another embodiment, a task item 125 may be included in a “now” contextual task list 140 according to context data determined through statistical analysis of sensor data and task item 125 data. For example, a determination may be made that a number of users mark a particular task item 125 as complete when they are in a particular GPS location. The GPS location may be GPS coordinates. When a user has the particular task item on his list (e.g., “Buy milk” (task item 125C)), a suggestion may be made to the user to complete the task item 125 (e.g., include the task item 125 in a “now” contextual list 140) based on statistical data of multiple users.

With reference still to FIG. 1, the example “now” contextual list 140 includes task item “Help John with college application” (task item 125A). The task item “Help John with college application” (task item 125A) may be included in the “now” contextual task list 140 because of a priority level 120 associated with it. According to embodiments, a priority level 120 may be associated with a task item 125 and may cause the task item 125 to be included in a “now” contextual list 140. Embodiments comprise an aging-out process for priority levels 120. To help prevent a task list from continuously growing and from including task items 125 that may not be of importance to a user by associated a priority level 120 with a task item 125, the task item 125 may be pinned to a user's “now” contextual list 140 for a period of time. As time passes, the priority level 120 of a task item 125 may decrease. As illustrated in FIG. 1, the priority level 120 may be displayed as a star. As should be appreciated, a star is for purposes of example only and is not limiting of other UI elements that may be utilized to represent a priority level 120.

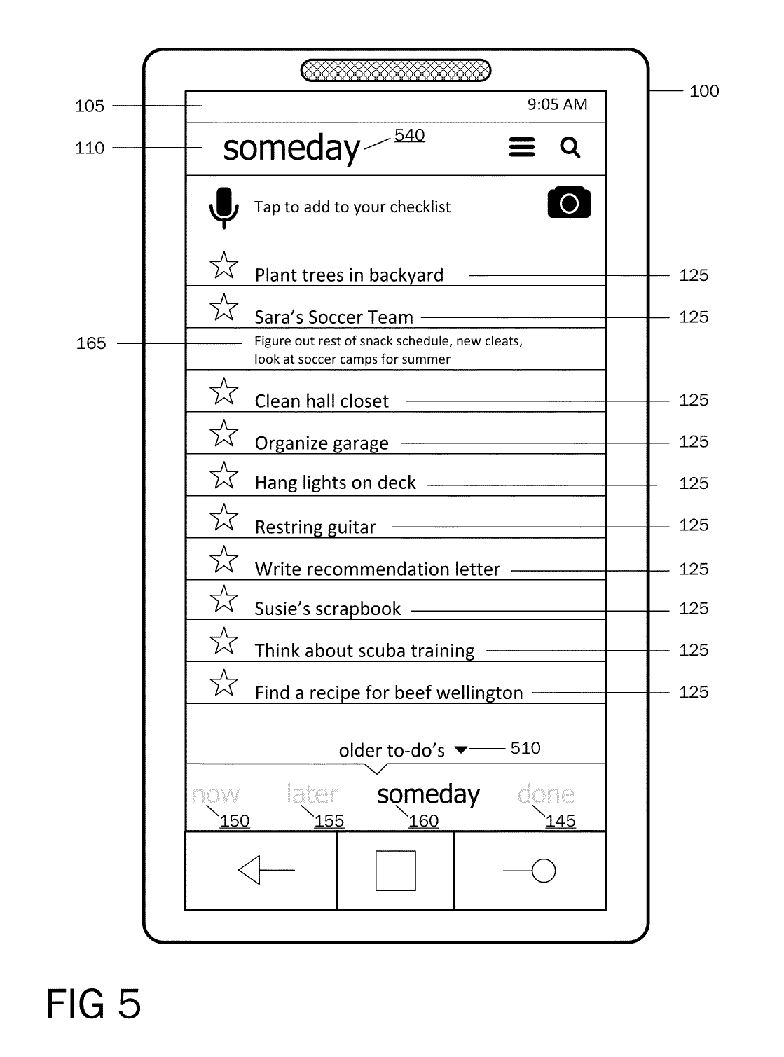

In FIG. 1, the priority level 120A associated with “Help John with college application” (task item 125A) is shown as high priority as indicated by a filled-in star and accordingly, “Help John with college application” (task item 125A) is displayed at the top of the “now” contextual task list 140. The task item “Get tennis racquet restrung” (task item 125B) includes a decreased priority level 120B as indicated by a faded or lesser-filled-in star. The priority level 120B may be decreased because of an amount of time that has passed since the task item 125B was input into the task application 950 or since the task item 125B was edited. According to embodiments, after a predetermined amount of time, a task item's 125 priority level 120 may decrease to a level where the task item 125 drops off a “now” contextual task list 140 to a “someday” contextual task list. The “someday” contextual task list will be described in further detail with respect to FIG. 5.

With reference still to FIG. 1, the example “now” contextual list 140 includes task item “Pack for beach” (task item 125D). The “Pack for beach” task item 125D may be included in the “now” contextual task list 140 because of context data associated with it, for example, time-based context data and identity-based context data. For example, a task item 125 may be displayed in a “now” contextual list 140 if a determination is made that a person associated with the task item 125, according to identity-based context data, is detected to be near the user. As illustrated, UI elements 130,135 may be displayed to show that a task item 125 has context data associated with it. For example, a bell or alarm UI element 130 may be displayed to indicate that the “Pack for beach” task item 125D includes time-based context data. The time-based context data may be a date that the user is going to the beach. An identity UI element 135 may be displayed to indicate that the “Pack for beach” task item 125D includes identity-based context data. For example, the identity-based context data may include the members of the user's family who are going to the beach. As can be appreciated, identity-based context data may also include a group, a team, a company, etc.

According to embodiments, a task item 125 may include a sub-task list 165. For example, the “Pack for beach” task item 125D may include a sub-task list 165 of items the user need to pack for the beach trip. Task items 125 and sub-task lists 165 may be selected for editing, deletion, or for display in a separate view.

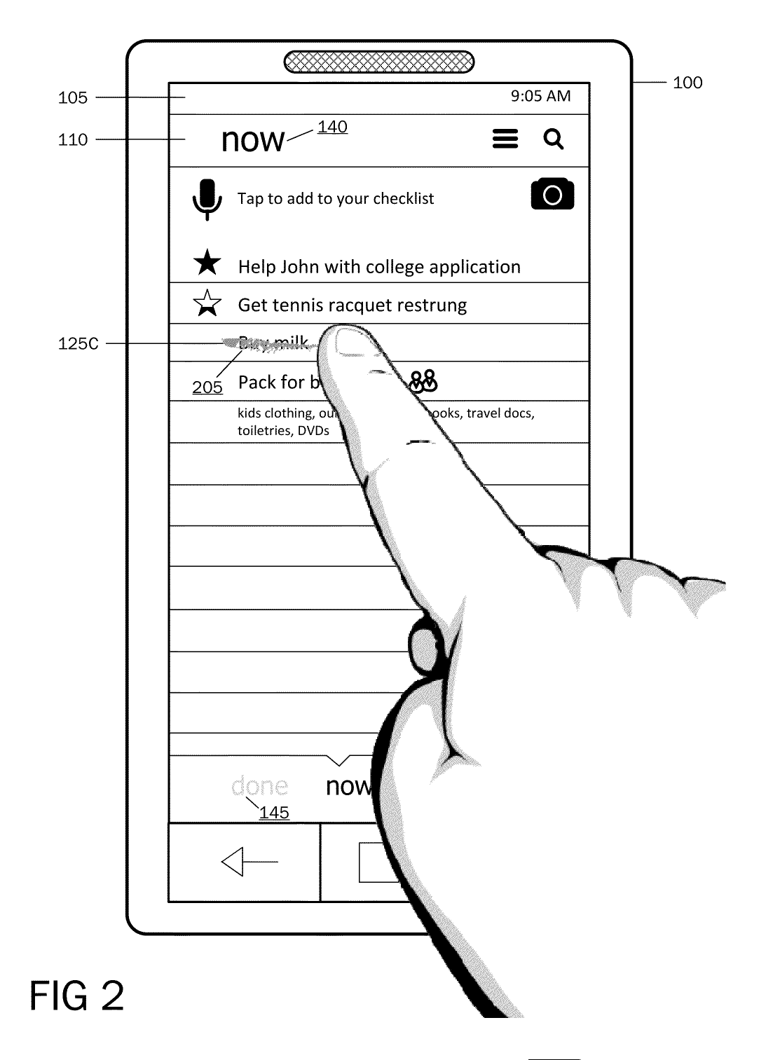

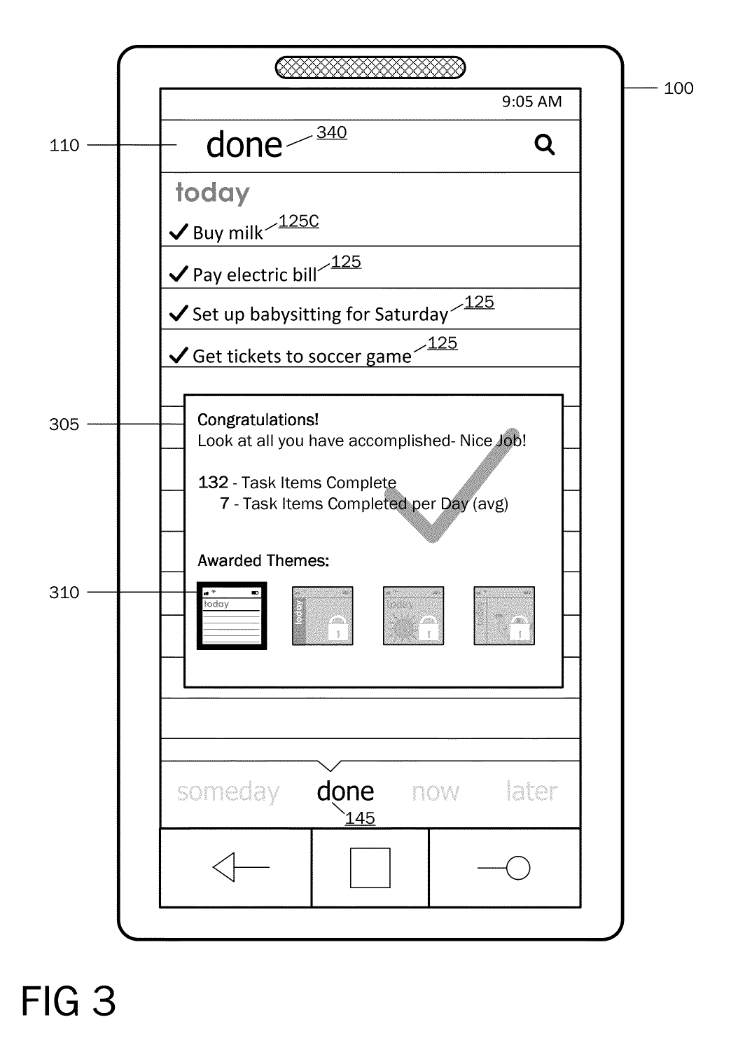

As illustrated in FIG. 2, a task item 125 may be marked as completed via a strike-through 205. For example, a user may swipe his finger across a task item 125 to mark the item as completed. When a task item 125 is marked as completed, the task item 125 may be moved to the “done” task list. According to embodiments, a completed task item 125 may be moved to the “done” task list immediately when a user marks the task item 125 as complete, or alternatively, may remain on the current task list for a given amount of time or until a given condition is met (e.g., after an hour, at the end of the day, when the user switches away from the task application 950, etc.). By delaying removal of completed task items 125, a user may feel a sense of accomplishment by viewing crossed-off task items 125 on a contextual task list. Selection of the “done” task list pane function 145 may provide a display of the “done” task list 340 as illustrated in FIG. 3. The “done” task list 340 may include task items 125 that have been marked as completed. Embodiments may provide for tracking a number of completed task items 125 and providing a reward to a user when a predetermined number of task items 125 have been completed. Rewards may be provided as motivation for a user to complete task items 125. For example and as illustrated in FIG. 3, a congratulations notification 305 is displayed and includes themes 310 as a reward from which a user may select to apply to the task application user interface (UI) 110. As should be appreciated, awarded themes 310 are for purposes of example only and are not limiting of other rewards that may be offered.

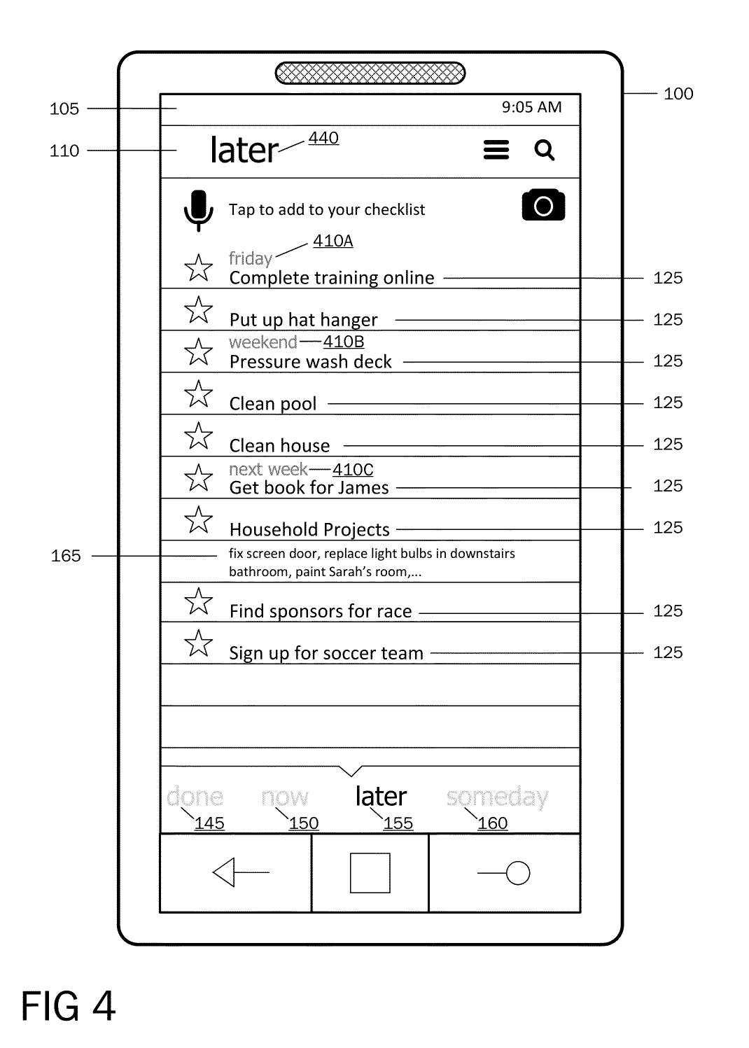

With reference now to FIG. 4, an example “later” contextual task list 440 is illustrated. According to embodiments, a “later” contextual task list 440 may include one or more task items 125 that are upcoming and have context data associated with them. A task item 125 included in a “later” contextual task list 440 may include task items 125 that have time-based context data, for example, a birthday, an anniversary, an appointment, a meeting, etc., location-based context data, identity-based context data, etc. A “later” contextual task list 440 may also include recurring task items. For example, a recurring task item 125 may include a reminder for a user to make sure he has purchased a birthday gift for his spouse by a certain date or to send a status report on a certain day of the week. Time-based context data may include specific time context data or fuzzy time context data. For example, a task item 125 may be to clean the house, and time-based context data associated with the task may be that the house needs to be cleaned before a party the user is hosting on Sunday at 6:00 PM. While the task 125 does not have a specific date or time associated with it, the task has a fuzzy time associated with it, with a deadline of Sunday at 6:00 PM. Accordingly, the example task may be included in the “later” contextual task list 440 and may be categorized in a time category 410. As illustrated in FIG. 4, time categories 410 may include such categories as a specific day of the week 410A (e.g., Friday), an upcoming weekend 410B, the next week 410C, next month, etc.

With reference now to FIG. 5, an example “someday” contextual task list 540 is illustrated. According to embodiments, a “someday” contextual task list 540 may include one or more task items 125 that may not have clear context data associated with them. For example, task items 125 that may be added to the “someday” contextual task list 540 may be tasks that a user may need to be handle or accomplish or that a user thinks of and wants to write down or record, but may be tasks that do not have context data, such as deadlines, location data, identity data, etc. associated with them. According to embodiments, “someday” contextual task list 540 task items 125 may be aged-out, wherein after a predetermined amount of time, a “someday” contextual task list 540 task item 125 may no longer appear in the “someday” contextual task list 540. Aged-out task items 125 may be accessed, for example, via a selection of a functionality control 510 which when selected, may cause a display of task items 125 that have been aged-out from the “someday” contextual task list 540.

According to embodiments, as a user enters a new task item 125, the task application 950 may automatically deduce and tag relevant context data from the task item 125. Each task item 125 may also have additional context data manually associated with it. According to one embodiment, upon selection of a task item 125, a task item edit UI 640 may be displayed as illustrated in FIG. 6. A task item edit UI 640 may include the task item 125 being edited and may also include selectable fields and functionalities for associating context data with the task item 125. A “notes” field 605 for inputting notes associated with the task item 125 may be provided. An input in the “notes” field 605 for the illustrated task item 125 “Write recommendation letter” in FIG. 6 may include, for example, bullet points the user wants to include in the recommendation letter, an address to send the letter, etc.

The task item edit UI 640 may also include a “when” field 610 for inputting or selecting time context data, for example, a date and/or time to complete the task 125. As illustrated, the “when” field 610 may include a selectable functionality 620 for accessing a calendaring UI.

Additionally, the task item edit UI 640 may also include a “where” field 620 for inputting or selecting location context data, wherein the location context data may be an address, business type, landmark, business name, etc. associated with the task 125. For example, if the user intends to write the recommendation letter at his office, the user may input or select his office address, company name, contact information, etc. to associate the location of his office with the task 125. As illustrated, a selectable functionality 625 may be included, which when selected, may provide access to a mapping UI which may be utilized to input or select location context data.

The task item edit UI 640 may also include a “who” field 630 for inputting or selecting identity context data. Identity context data may include associating a task item 125 with one or more people or groups for whom a task item is being done and/or associating a task item 125 with one or more people or groups with whom a task item is being done. One or more people or groups associated with the task item 125 may be inputted or selected. A selectable functionality 635 may be included, which when selected, may provide access to the user's contacts information. The user may be able to select one or more contacts to associate with the task item 125. Additionally, a delete task functionality control 645 may be provided for allowing the user to delete a task item 125.

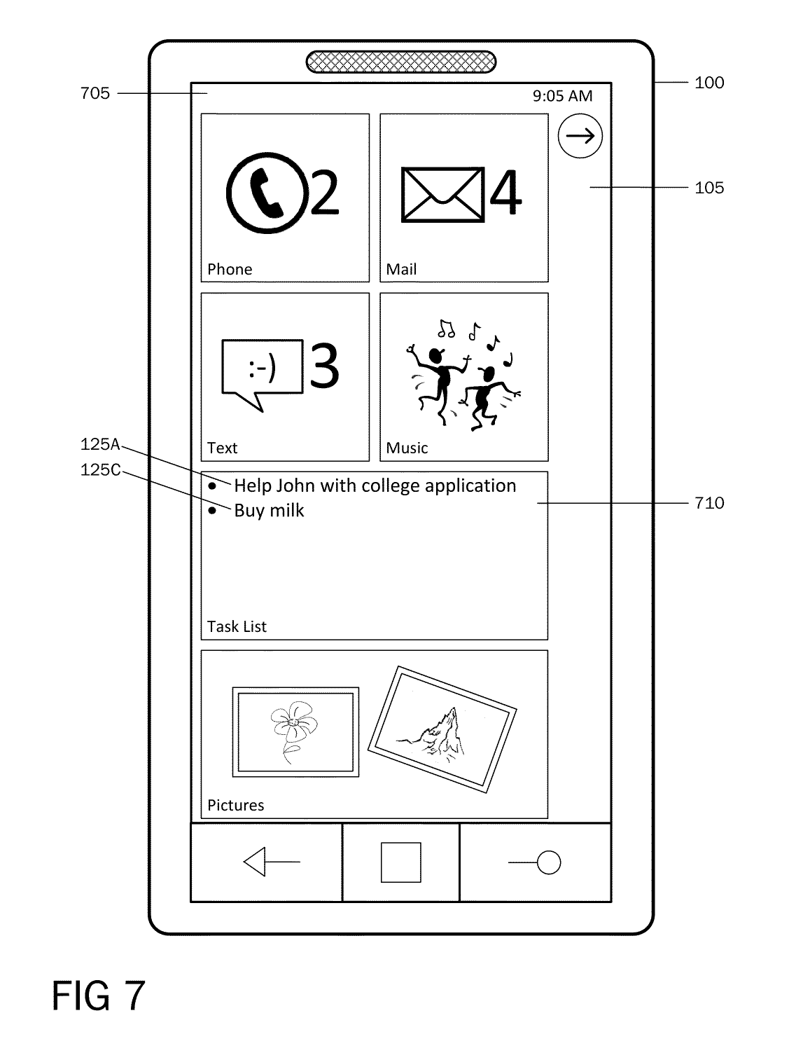

According to embodiments, as a user progresses through his/her day, various tools, applications, mechanisms, and functionalities associated with the user's mobile computing device 100 may detect the ever-changing context of the user's environment (e.g., time, location, people, activity, etc.). As the context changes, task items 125 may be automatically sorted into a contextual task list 140,440,540 and alerts to task items 125 associated with the present or upcoming context may be provided to the user to alert the user of an upcoming opportunity to achieve the task items 125. For example and as illustrated in FIG. 7, a visual notification 710 may be displayed on a home screen 705 or lock screen on the user's mobile computing device 100, or may appear as a pop-up notification 710 on a current UI being displayed on the display screen 105. The visual notification 710 may include task items 125 that have been determined to be associated with a current or upcoming context and task items 125 of a high priority level 120. For example, the “Help John with college application” task item 125A may be included in the visual notification 710 because of the priority level 120 associated with it. The “Buy milk” task item 125C may be included in the visual notification 710 because the location of the mobile computing device 100, for example, as determined by a GPS system, is near location context data associated with the task item 125C. The location context data associated with the task item 125C may be “grocery store” or may be a specific store. Upon detection of the mobile computing device 100 being near to a grocery store or the specific store, the visual notification 710 may be displayed. Additionally, other types of notifications may be provided, for example, audible and/or tactile alerts.

Although the examples illustrated in the figures show touchscreen UIs on a mobile computing device 100, embodiments may be utilized on a vast array of devices including, but not limited to, desktop computer systems, wired and wireless computing systems, mobile computing systems (e.g., mobile telephones, netbooks, tablet or slate type computers, notebook computers, and laptop computers), hand-held devices, IP telephones, gaming devices, cameras, multiprocessor systems, microprocessor-based or programmable consumer electronics, minicomputers, and mainframe computers. As should be appreciated, the configuration and location of UI components illustrated in FIGS. 1-7 are for purposes of example only and are not limiting of other configurations that may be possible.

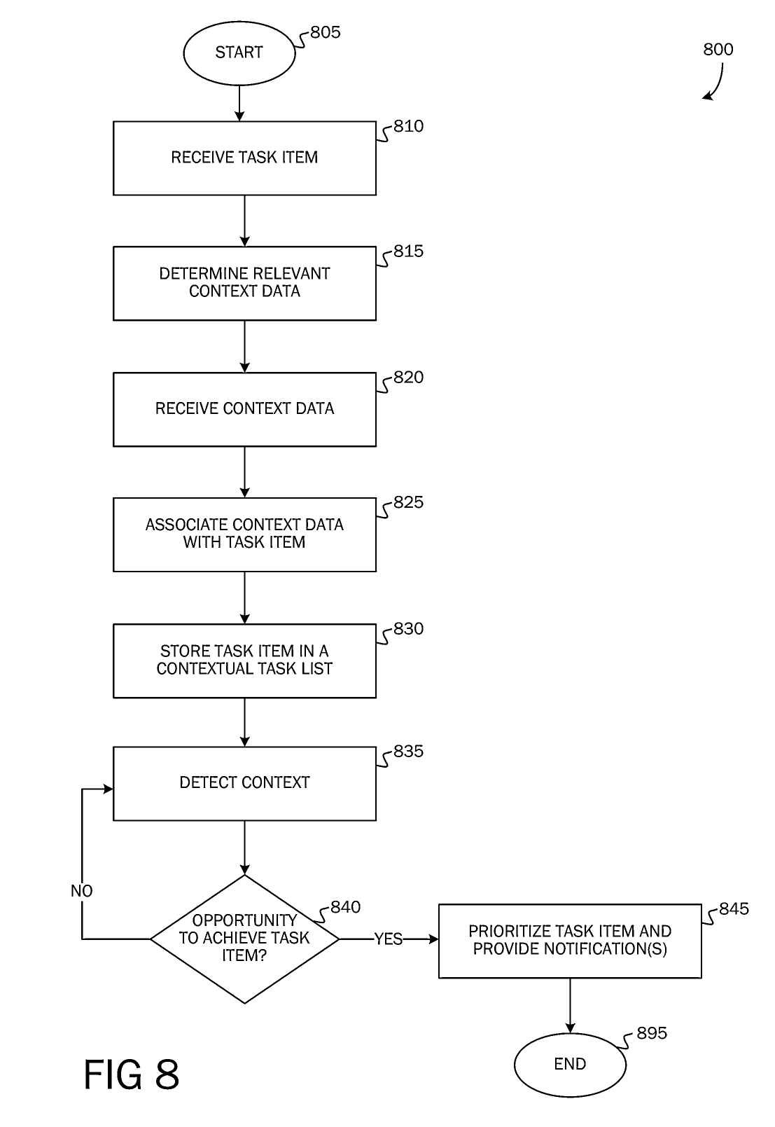

With reference now to FIG. 8, a flow chart of a method 800 for providing automatic task management based on content and context awareness is illustrated. The method 800 starts at OPERATION 805 and proceeds to OPERATION 810 where a task item 125 is received. A task item 125 may be received when a user inputs a task item 125 or when a task item 125 is shared between users. A user may input a task item 125 via various input methods which may include, but is not limited to, entry via touch input on a touchscreen 105, entry via a selection of buttons or keys, voice input, image input (e.g., via mobile computing device camera), etc.

The method 800 proceeds to OPERATION 815, where relevant context data may be determined. A task item 125 may be parsed for relevant context data. For example, a task item 125 such as “Clean house” may be parsed, wherein the term “house” may be recognized and associated with location context data for the user's home. At OPERATION 820, context data may be received. For example, the user may input context data such as, but not limited to, time context data, location context data, identity context data, keyword context data, etc. The method 800 proceeds to OPERATION 825, where context data that has been determined and received may be associated with the task item 125.

At OPERATION 830, the task item 125 may be stored in a contextual task list. According to embodiments, if the task item 125 has a priority level 120 associated with it or if the task item 125 is relevant to an immediate context, the task item 125 may be stored in a “now” contextual task list 140. If the task item 125 is upcoming and has context data associated with it, the task item 125 may be stored in a “later” contextual task list 440. If the task item 125 does not have contact data associated with it, the task item 125 may be stored in a “someday” contextual task list 540.

At OPERATION 835, context may be detected. According to embodiments and as described above, context may be detected via various tools, applications, mechanisms, and functionalities associated with the user's mobile computing device 100. Contexts that maybe detected includes, but is not limited to, date, time, location, people, incoming and outgoing communications, a user's actions, etc. One example of detecting context (OPERATION 835) may include determining a user is travelling in an airplane via detection of barometric pressure. Another example of detecting context may include determining that a user is with a certain person (e.g., a person associated with a task item 125) via detection of the person's voice using a microphone on the user's mobile computing device 100, via social networking communications, via accessing a calendaring application (e.g., the user's and/or the person's), via detection of the person via facial recognition using a camera on the user's mobile computing device 100, etc. Other examples may include detecting a user's location (e.g., proximity to a specific location associated with a task item 125, proximity to a location determined to be associated with a task item 125 according to statistical analysis of the task item, location relative to other people, etc.) via GPS, RFID input, via accessing a calendaring application, etc.; detecting traffic congestion (e.g., along a route to a location associated with a task item 125); detecting a user's activity (e.g., running, driving, etc.) via accelerometer or GPS information; etc.

The method 800 may proceed to DECISION OPERATION 840, where a determination may be made to determine whether the detected context correlates with context data associated with a task item 125 or if the detected context provides an opportunity for the user to achieve a task item 125. For example, determine whether the detected context correlates with context data associated with a task item 125 or if the detected context provides an opportunity for the user to achieve a task item 125 (DECISION OPERATION 840) may include detecting that the user is driving and determining that the time may not be opportune for the user to complete a task item 125 or to be notified 710 of a task item 125. As another example, a user may input a task item 125 such as “learn how to build a deck.” Web content for a friend of the user available via social media, a calendaring application, or other relevant sources may be accessed (e.g., via public APIs) (OPERATION 815) and may be parsed for information relating to keywords from the user's task item 125. For example, the user may have a friend, Bob, who has just completed building a deck as determined via his web content. This information may be discovered, stored as context data, and associated with the user's task item 125 (OPERATION 825). Accordingly, upon detection of the user and Bob being in the same location (OPERATION 835), a determination may be made that the present context presents an opportunity for the user to achieve or complete a task item 125 (DECISION OPERATION 840).

If a determination is made at DECISION OPERATION 840 that the present context does not present an opportunity for the user to achieve/complete a task item 125, the method 800 may return to OPERATION 835. If a determination is made that the present context does present an opportunity for the user to achieve/complete a task item 125, the method 800 may proceed to OPERATION 845, where the task item 125 may be prioritized, that is, the task item 125 may be moved from “later” contextual task list 440 to the “now” contextual task list 140. Additionally, a notification 710 may be provided to alert the user of the opportunity to achieve/complete the task item 125. The user may choose to act on the task item 125, or alternatively, may choose to postpone the task item 125 or ignore the notification. If the user ignores or postpones the task item 125, a notification 710 may be provided the next time the opportunity is relevant. The method 800 ends at OPERATION 895.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, IP phones, gaming devices, multiprocessor systems, microprocessor-based or programmable consumer electronics, minicomputers, and mainframe computers. In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected.

Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. As described above, gesture entry may also include an input made with a mechanical input device (e.g., with a mouse, touchscreen, stylus, etc.), the input originating from a bodily motion that can be received, recognized, and translated into a selection and/or movement of an element or object on a graphical user interface that mimics the bodily motion. FIGS. 9 through 11 and the associated descriptions provide a discussion of a variety of operating environments in which embodiments of the invention may be practiced. However, the devices and systems illustrated and discussed with respect to FIGS. 9 through 11 are for purposes of example and illustration and are not limiting of a vast number of computing device configurations that may be utilized for practicing embodiments of the invention, described herein.

FIG. 9 is a block diagram illustrating example physical components (i.e., hardware) of a computing device 900 with which embodiments of the invention may be practiced. The computing device components described below may be suitable for the computing devices described above. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories. The system memory 904 may include an operating system 905 and one or more program modules 906 suitable for running software applications 920 such as a task application 950. The operating system 905, for example, may be suitable for controlling the operation of the computing device 900. Furthermore, embodiments of the invention may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the processing unit 902, the program modules 906, such as the task application 950, may perform processes including, for example, one or more of the stages of method 800. The aforementioned process is an example, and the processing unit 902 may perform other processes. Other program modules that may be used in accordance with embodiments of the present invention may include electronic mail and contacts applications, word processing applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the task application 950 may be operated via application-specific logic integrated with other components of the computing device 900 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 900 may also have one or more input device(s) 912 such as a keyboard, a mouse, a pen, a sound input device, a touch input device, a microphone, a gesture recognition device, etc. The output device(s) 914 such as a display, speakers, a printer, etc. may also be included. The aforementioned devices are examples and others may be used. The computing device 900 may include one or more communication connections 916 allowing communications with other computing devices 918. Examples of suitable communication connections 916 include, but are not limited to, RF transmitter, receiver, and/or transceiver circuitry; universal serial bus (USB), parallel, or serial ports, and other connections appropriate for use with the applicable computer readable media.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media and communication media. Computer storage media may include volatile and nonvolatile, removable and non-removable media implemented in any method or technology for storage of information, such as computer readable instructions, data structures, program modules, or other data. The system memory 904, the removable storage device 909, and the non-removable storage device 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 900. Any such computer storage media may be part of the computing device 900.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

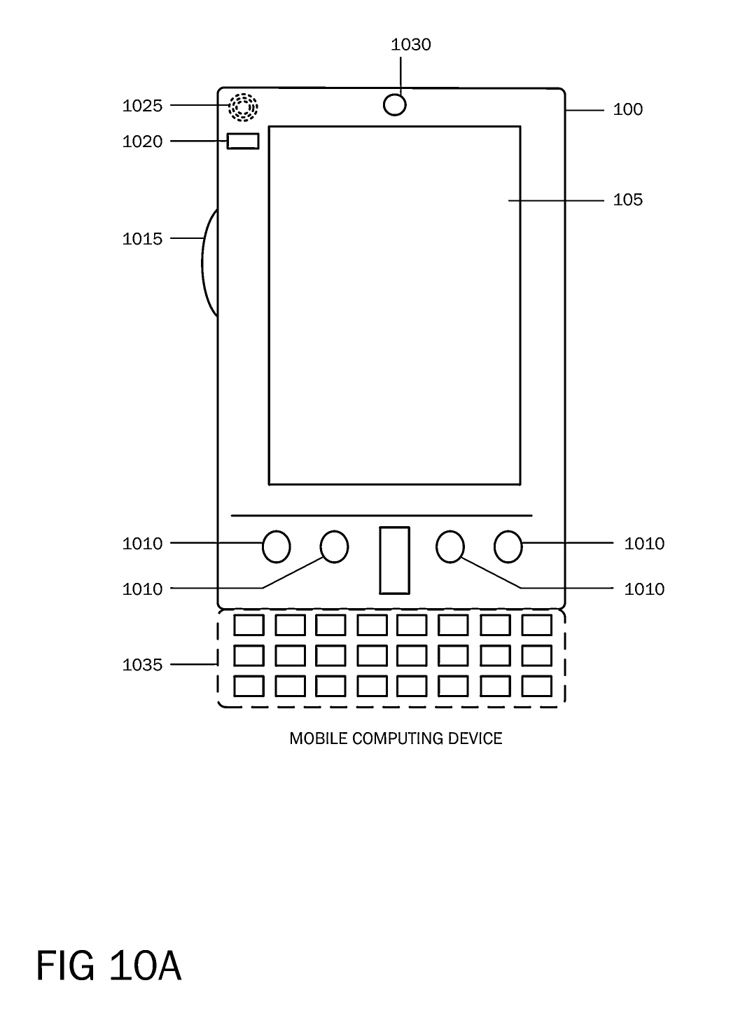

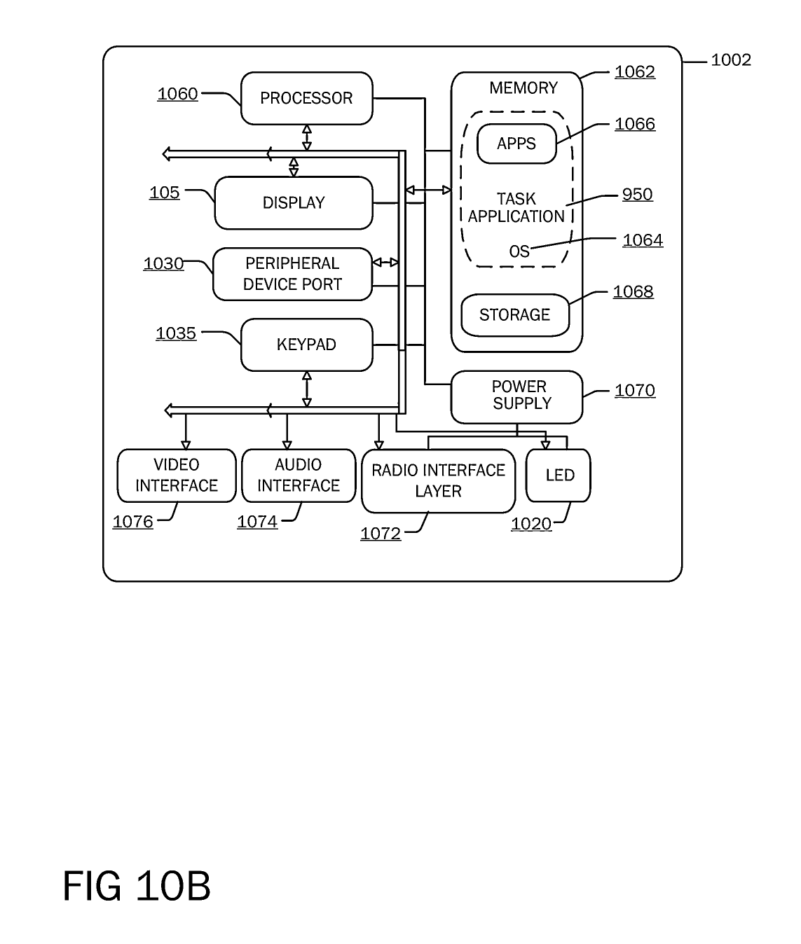

FIGS. 10A and 10B illustrate a mobile computing device 100, for example, a mobile telephone, a smart phone, a tablet personal computer, a laptop computer, and the like, with which embodiments of the invention may be practiced. With reference to FIG. 10A, an exemplary mobile computing device 100 for implementing the embodiments is illustrated. In a basic configuration, the mobile computing device 100 is a handheld computer having both input elements and output elements. The mobile computing device 100 typically includes a display 105 and one or more input buttons 1010 that allow the user to enter information into the mobile computing device 100. The display 105 of the mobile computing device 100 may also function as an input device (e.g., a touch screen display). If included, an optional side input element 1015 allows further user input. The side input element 1015 may be a rotary switch, a button, or any other type of manual input element. In alternative embodiments, mobile computing device 100 may incorporate more or less input elements. For example, the display 105 may not be a touch screen in some embodiments. In yet another alternative embodiment, the mobile computing device 100 is a portable phone system, such as a cellular phone. The mobile computing device 100 may also include an optional keypad 1035. Optional keypad 1035 may be a physical keypad or a “soft” keypad generated on the touch screen display. In various embodiments, the output elements include the display 105 for showing a graphical user interface (GUI), a visual indicator 1020 (e.g., a light emitting diode), and/or an audio transducer 1025 (e.g., a speaker). In some embodiments, the mobile computing device 100 incorporates a vibration transducer for providing the user with tactile feedback. In yet another embodiment, the mobile computing device 100 incorporates input and/or output ports, such as an audio input (e.g., a microphone jack), an audio output (e.g., a headphone jack), and a video output (e.g., a HDMI port) for sending signals to or receiving signals from an external device.

FIG. 10B is a block diagram illustrating the architecture of one embodiment of a mobile computing device. That is, the mobile computing device 100 can incorporate a system (i.e., an architecture) 1002 to implement some embodiments. In one embodiment, the system 1002 is implemented as a “smart phone” capable of running one or more applications (e.g., browser, e-mail, calendaring, contact managers, messaging clients, games, and media clients/players). In some embodiments, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 100, including the task application 950 described herein.

The system 1002 has a power supply 1070, which may be implemented as one or more batteries. The power supply 1070 might further include an external power source, such as an AC adapter or a powered docking cradle that supplements or recharges the batteries. The system 1002 may also include a radio 1072 that performs the function of transmitting and receiving radio frequency communications. The radio 1072 facilitates wireless connectivity between the system 1002 and the “outside world”, via a communications carrier or service provider. Transmissions to and from the radio 1072 are conducted under control of the operating system 1064. In other words, communications received by the radio 1072 may be disseminated to the application programs 1066 via the operating system 1064, and vice versa.

The radio 1072 allows the system 1002 to communicate with other computing devices, such as over a network. The radio 1072 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 1002 provides notifications using the visual indicator 1020 that can be used to provide visual notifications and/or an audio interface 1074 producing audible notifications via the audio transducer 1025. In the illustrated embodiment, the visual indicator 1020 is a light emitting diode (LED) and the audio transducer 1025 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 1025, the audio interface 1074 may also be coupled to a microphone to receive audible input, such as to facilitate a telephone conversation and for voice recognition. In accordance with embodiments of the present invention, the microphone may also serve as an audio sensor to facilitate control of notifications, as will be described below. The system 1002 may further include a video interface 1076 that enables an operation of an on-board camera 1030 to record still images, video stream, facial recognition, and the like.

The system 1002 may comprise a variety of other types of sensors operable to detect context. For example, the system may comprise an accelerometer for detecting acceleration, and can be used to sense orientation, vibration, and/or shock. The system 1002 may contain a global positioning system (GPS) system (e.g., GPS send/receive functionality), which when coupled with a navigation application, can pinpoint a device's 1000 location, give directions to a provided destination, and may provide information about nearby businesses. A barometric pressure-sensing device may be included for sensing barometric pressure.

A mobile computing device 1000 implementing the system 1002 may have additional features or functionality. For example, the mobile computing device 100 may also include additional data storage devices (removable and/or non-removable) such as, magnetic disks, optical disks, or tape. Such additional storage is illustrated in FIG. 10B by the non-volatile storage area 1068. Computer storage media may include volatile and nonvolatile, removable and non-removable media implemented in any method or technology for storage of information, such as computer readable instructions, data structures, program modules, or other data.

Data/information generated or captured by the mobile computing device 100 and stored via the system 1002 may be stored locally on the mobile computing device 100, as described above, or the data may be stored on any number of storage media that may be accessed by the device via the radio 1072 or via a wired connection between the mobile computing device 100 and a separate computing device associated with the mobile computing device 100, for example, a server computer in a distributed computing network, such as the Internet. As should be appreciated such data/information may be accessed via the mobile computing device 100 via the radio 1072 or via a distributed computing network. Similarly, such data/information may be readily transferred between computing devices for storage and use according to well-known data/information transfer and storage means, including electronic mail and collaborative data/information sharing systems.

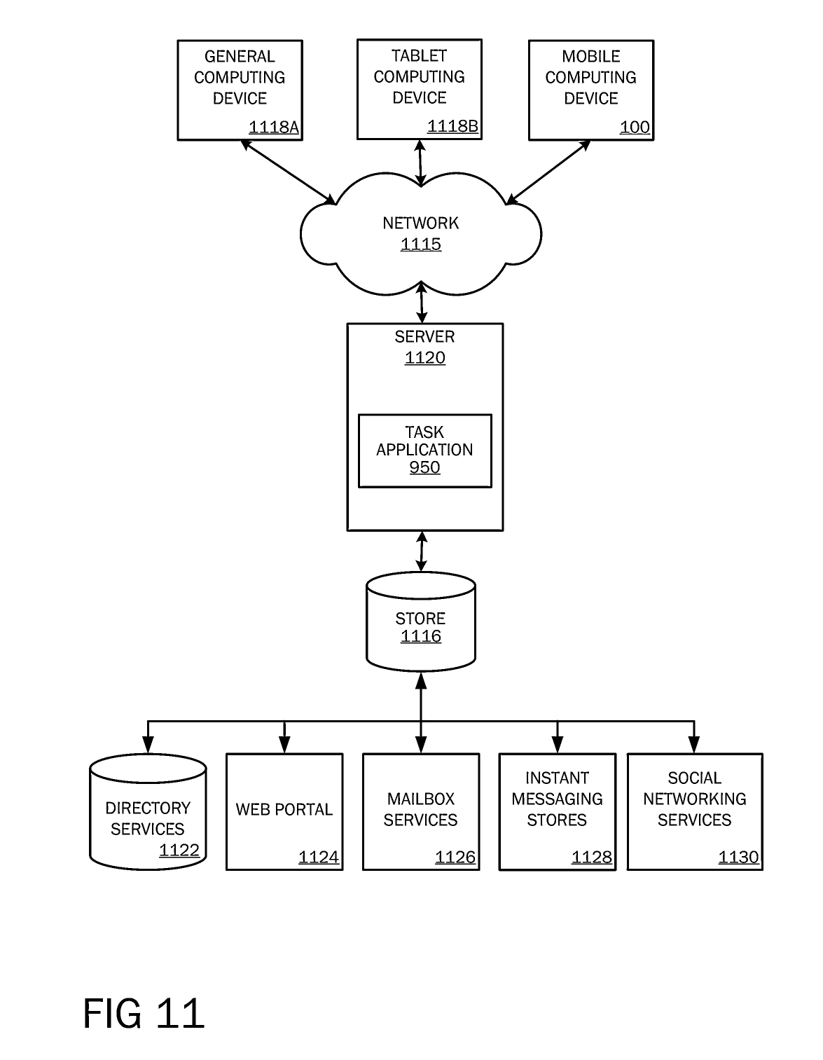

FIG. 11 illustrates one embodiment of the architecture of a system for providing the task application 950 to one or more client devices, as described above. Content developed, interacted with or edited in association with the task application 950 may be stored in different communication channels or other storage types. For example, various documents may be stored using a directory service 1122, a web portal 1124, a mailbox service 1126, an instant messaging store 1128, or a social networking site 1130. Task application 950 may use any of these types of systems or the like for providing automatic task management based on content and context awareness, as described herein. A server 1120 may provide the task application 950 to clients. As one example, the server 1120 may be a web server providing the task application 950 over the web. The server 1120 may provide the task application 950 over the web to clients through a network 1115. By way of example, the client computing device 1118 may be implemented as the computing device 900 and embodied in a personal computer 1118A, a tablet computing device 111813 and/or a mobile computing device 100 (e.g., a smart phone). Any of these embodiments of the client computing device 1118 may obtain content from the store 1116. In various embodiments, the types of networks used for communication between the computing devices that make up the present invention include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A method for providing automatic task management, the method comprising:
receiving a task item;
parsing the task item for relevant context data;
associating the relevant context data with the task item;
storing the task item in a contextual task list;
detecting context; and
upon detection of context relating to relevant context data associated with the task item, updating the task item.

2. The method of claim 1, further comprising receiving relevant context data associated with the task item.

3. The method of claim 1, wherein parsing the task item for relevant context data comprises parsing the task item for one or more of:
time data;
date data;
location data;
identity data;
object data;
keyword data; or
activity data.

4. The method of claim 1, wherein storing the task item in a contextual task list comprises storing the task item in one of:
a “now” contextual task list;
a “later” contextual task list; or
a “someday” contextual task list.

5. The method of claim 4, wherein storing the task item in the “now” contextual task list comprises storing a task that is relevant to an immediate context.

6. The method of claim 4, wherein storing the task item in the “later” contextual task list comprises storing a task that is upcoming and has relevant context data associated with it.

7. The method of claim 4, wherein storing the task item in the “someday” contextual task list comprises storing a task that does not have relevant context data associated with it.

8. The method of claim 7, further comprising removing the task item from display in the “someday” contextual task list after a predetermined amount of time.

9. The method of claim 8, further comprising providing a functionality for viewing task items that have been removed from display from the “someday” contextual task list.

10. The method of claim 1, wherein detecting context comprises detecting one or more of:
time;
date;
location;
identity;
keyword; or
a user's activity.

11. The method of claim 1, wherein updating the task item upon detection of context relating to relevant context data associated with the task item comprises sorting the task item into a “now” contextual task list.

12. The method of claim 11, further comprising providing a notification, the notification provided to alert a user of a present or upcoming opportunity to achieve or complete the task item.

13. The method of claim 1, further comprising:
receiving a priority level associated with the task item; and
pinning the task item to a “now” contextual task list.

14. The method of claim 13, further comprising:
decreasing the priority level associated with the task item after a predetermined amount of time; and
removing the task item from the “now” contextual task list after a predetermined decrease of priority level associated with the task item.

15. The method of claim 1, further comprising providing a user interface for allowing a user to input relevant context data.

16. The method of claim 1, further comprising:
receiving an indication of a task item being completed; and
moving the task item to a “done” contextual task list.

17. A system for providing automatic task management, the system comprising:
a memory storage; and
a processing unit coupled to the memory storage, wherein the processing unit is operable to:
receive a task item;
parse the task item for relevant context data, the relevant context data comprising one or more of:
time data;
date data;
location data; or
people data;
associate the relevant context data with the task item; and
store the task item in one of:
a “now” contextual task list;
a “later” contextual task list; or
a “someday” contextual task list.

18. The system of claim 17, wherein the processing unit is further operable to:
detect context;
upon detection of context relating to relevant context data associated with the task item:
prioritize the task item;
store the task item in the “now” contextual task list; and
provide a notification, the notification alerting a user of a present or upcoming opportunity to achieve or complete the task item.

19. The system of claim 17, wherein the processing unit if further operable to:
remove the task item from display in the “someday” contextual task list after a predetermined amount of time;
provide a functionality for viewing task items that have been removed from display from the “someday” contextual task list;
receive a priority level associated with the task item;
pin the task item to a “now” contextual task list;
decrease the priority level associated with the task item after a predetermined amount of time; and
remove the task item from the “now” contextual task list.

20. A computer-readable medium containing computer-executable instructions which when executed by a computer perform a method for providing automatic task management, the method comprising:
receiving a task item;
parsing the task item for relevant context data, the relevant context data comprising one or more of:
time data;
date data;
location data; or
people data;
associating the relevant context data with the task item;
storing the task item in one of:
a “now” contextual task list;
a “later” contextual task list; or
a “someday” contextual task list;
detecting context; and
upon detection of context relating to relevant context data associated with the task item, prioritizing the task item:
storing the task item in the “now” contextual task list; and
providing a notification, the notification alerting a user of a present or upcoming opportunity to achieve or complete the task item.
